(19) United States
(12) Patent Application Publication
(10) Pub. No.: US 2025/0002154 A1
(43) Pub. Date: Jan. 2, 2025

(54) SEAT SYSTEM FOR AIRPLANE AND AIRPLANE HAVING THE SAME

(71) Applicants: Young Seo CHO, Paju-si (KR); Young Jai CHO, Paju-si (KR)

(72) Inventors: Young Seo CHO, Paju-si (KR); Young Jai CHO, Paju-si (KR)

(21) Appl. No.: 18/215,089

(22) Filed: Jun. 27, 2023

(51) Int. Cl. B64D 11/06

(52) U.S. Cl. CPC B64D 11/0601

(57) ABSTRACT

Disclosed are a seat system for an airplane and an airplane having the same. The seat system for the airplane of the present disclosure includes a lower seat system provided in a first space part of an airplane body; and an upper seat system provided in a second space part disposed above the first space part, in which the upper seat system includes a plurality of seat parts, the plurality of seat parts have at least one arrangement structure selected from a V-shaped arrangement structure, a linear arrangement structure, and a hatched arrangement structure, and the plurality of seat parts are continuously arranged.

### BACKGROUND OF THE INVENTION

### Field of the Invention

The present disclosure relates to a seat system, and more particularly, to a seat system for an airplane and an airplane having the same capable of increasing space efficiency and making it possible for a passenger to visually feel stability and luxury in a cabin space by combining an upper seat system and a lower seat system.

### Description of the Related Art

An airplane is an object that may fly through the air while carrying people or goods by using the lift of fixed wings.

These airplanes may be classified into several types depending on a use, a propulsion method, a wing shape, etc.

Among the airplanes, airliners are intended to transport people and have seats from at least 20 to 800. For reference, an airplane with 20 seats or less is called a commuter or an air taxi.

The seats of such an airliner are generally divided into first class, business class, and economy class.

These classes are divided according to a space of the seat and a service class to be provided.

In other words, the first seat is also called a sleeper seat, in which the seat may be unfolded at 180° to take a lying posture, and the business seat does not lie down like the first class, but has a wide distance from the front seat to take a comfortable posture with legs stretched out.

In contrast, the economy class is cheaper than first class, but lacks convenience.

On the other hand, conventional first and business classes have a wide required space of the seat and cannot create a large demand due to a higher seat price than the price of the economy class.

The idea of a conventional duplex seat has high space efficiency, but it is burdensome to accommodate the interior of an airplane cabin from an airline's viewpoint, so that an improvement plan thereof is required.

The above-described technical configuration is the background art for helping in the understanding of the present disclosure, and does not mean a conventional technology widely known in the art to which the present disclosure pertains.

### SUMMARY OF THE INVENTION

The present disclosure has been made in an effort to provide a seat system for an airplane and an airplane having the same capable of increasing space efficiency and making it possible for a passenger to visually feel stability and luxury in a cabin space by combining an upper seat system and a lower seat system.

According to an aspect of the present disclosure, there is provided a seat system for an airplane including: a lower seat system provided in a first space part of an airplane body; and an upper seat system provided in a second space part disposed above the first space part, in which the upper seat system includes a plurality of seat parts, the plurality of seat parts have at least one arrangement structure selected from a V-shaped arrangement structure, a linear arrangement structure, and a hatched arrangement structure, and the plurality of seat parts are continuously arranged.

The lower seat system may include a side seat part provided in the first space part; and a first seat part disposed to be spaced apart from the side seat part.

The side seat parts may be disposed on both sides of the first seat part and are arranged in a straight line in a direction from the head to the tail of the airplane body.

A pair of first corridors may be provided in the first space part, and the first seat part may include a first seat body provided between the pair of first corridors and provided as a seating area for a user.

The first seat part may further include a blocking body disposed close to the first seat body to block a line of sight with the passenger sitting on the side seat part.

In the first space part in the region where the first seat part is provided, a plurality of support partitions may be provided to support a bottom part of the second space part.

The plurality of seat parts having the V-shaped arrangement structure may include a plurality of second seat parts disposed in a V-shape with a second corridor provided in the second space part interposed therebetween.

The plurality of second seat parts may include a second seat body provided as a seating area for passengers; and a seat accommodating body which blocks the lines of sight of passengers seated on the second seat body and other passengers and accommodates the second seat body therein.

The seat accommodating body may include a front wall disposed in the head direction of the airplane body; a first side wall provided at one end of the front wall; a rear wall provided at one end of the first side wall and disposed in parallel with the front wall; a second side wall provided at one end of the rear wall and disposed in parallel with the first side wall; and a body door provided on the second side wall.

The plurality of second seat parts may be disposed so that the first side wall and the second side wall come into contact with each other.

The first side wall and the second side wall may be detachably coupled to each other with a fastening member.

The plurality of seat parts having the V-shaped arrangement structure may be disposed above a first seat part provided in the lower seat system.

The plurality of seat parts having the hatched arrangement structure may include a plurality of third seat parts arranged in a hatched shape in the second space part.

The plurality of third seat parts may include a third seat body provided as a seating area for passengers; a first accommodating body which blocks the lines of sight of passengers seated on the third seat body and other passengers and accommodates the third seat body therein; and a second accommodating body provided with a space separated from the first accommodating body and accommodating the third seat body therein.

The first accommodating body may include a first body wall; a second body wall provided at one end of the first body wall; a third body wall provided at one end of the second body wall and disposed in parallel with the first body wall; a fourth body wall provided at one end of the third body wall and disposed in parallel with the second body wall; and a first door provided on the fourth body wall.

The second accommodating body may include a fifth body wall provided on the third body wall and disposed in a straight line with the fourth body wall; and a sixth body wall provided at an end of the fifth body wall and disposed in parallel with the third body wall.

In the third seat part, the second body wall may be disposed in contact with the fourth body wall and the fifth body wall.

The second body wall may be detachably coupled to the fourth body wall and the fifth body wall by using a fastening member.

The plurality of seat parts having the linear arrangement structure may include a plurality of fourth seat parts arranged in a linear shape in the second space part.

The plurality of fourth seat parts may include a fourth seat body provided as a seating area for passengers; and a third accommodating body which blocks the lines of sight of passengers seated on the fourth seat body and other passengers and accommodates the fourth seat body therein.

A pair of fourth seat bodies may be provided in the third accommodating body, and the third accommodating body may be provided with a partition wall to block the lines of sight of passengers seated on the pair of fourth seat bodies.

The plurality of fourth seat parts may further include a fifth seat part disposed vertically to the fourth seat body and provided as a seating area for passengers.

The seat system for the airplane may further include the lower seat system and a monitor and a table provided in the lower seat system.

According to another aspect of the present disclosure, there is provided an airplane including: an airplane body having a first space part and a second space part disposed above the first space part; a lower seat system provided in the first space part; and an upper seat system provided in the second space part, in which the upper seat system includes a plurality of seat parts, the plurality of seat parts have at least one arrangement structure selected from a V-shaped arrangement structure, a linear arrangement structure, and a hatched arrangement structure, and the plurality of seat parts are continuously arranged.

The airplane body may include a plurality of shelf boxes; a pair of first corridors disposed to be spaced apart from each other in the first space part; a first step provided to move from the first space part to the second space part; and a second step provided to move from the first space part to the second space part and spaced apart from the first step.

According to the exemplary embodiments of the present disclosure, it is possible to increase space efficiency by combining an upper seat system and a lower seat system.

In addition, it is possible for passengers to visually feel stability and luxury for a cabin space.

Furthermore, it is possible to provide customers with airline seats at a reasonable price.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically illustrating a seat system for an airplane according to a first exemplary embodiment of the present disclosure;

FIG. 2 is a front cross-sectional view schematically illustrating that the seat system for the airplane illustrated in FIG. 1 is disposed on an airplane body;

FIG. 3 is a perspective view illustrating regions of a side seat part and a first seat part illustrated in FIG. 1;

FIG. 4 is a perspective view schematically illustrating a seat system for an airplane according to a second exemplary embodiment of the present disclosure;

FIG. 5 is a perspective view illustrating a third seat part illustrated in FIG. 4;

FIG. 6 is a perspective view schematically illustrating a seat system for an airplane according to a third exemplary embodiment of the present disclosure;

FIG. 7 is a perspective view schematically illustrating a fourth seat part and a fifth seat part illustrated in FIG. 6; and

FIG. 8 is a perspective view schematically illustrating a seat system for an airplane according to a fourth exemplary embodiment of the present disclosure.

### DETAILED DESCRIPTION OF THE PREFERRED EMBODIMENT

In order to fully understand the present disclosure, operational advantages of the present disclosure and objects to be achieved by implementing the present disclosure, the present disclosure will be described with reference to the accompanying drawings which illustrate preferred exemplary embodiments of the present disclosure and the contents illustrated in the accompanying drawings.

Hereinafter, preferred exemplary embodiments of the present disclosure will be described in detail with reference to the accompanying drawings. Like reference numerals illustrated in the respective drawings designate like members.

The airplane referred to in the exemplary embodiment includes airliners classified according to usage.

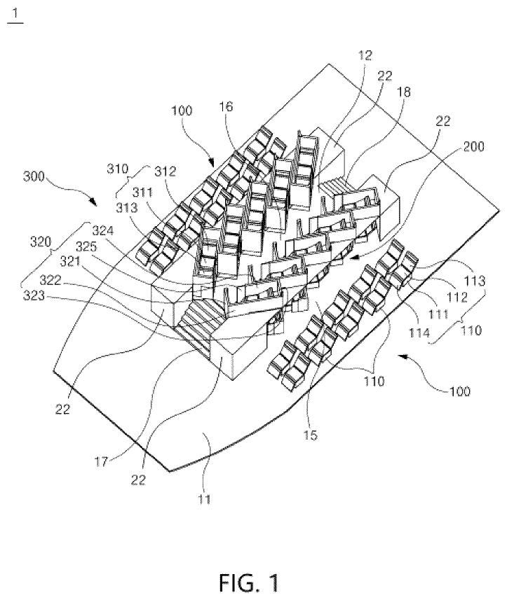

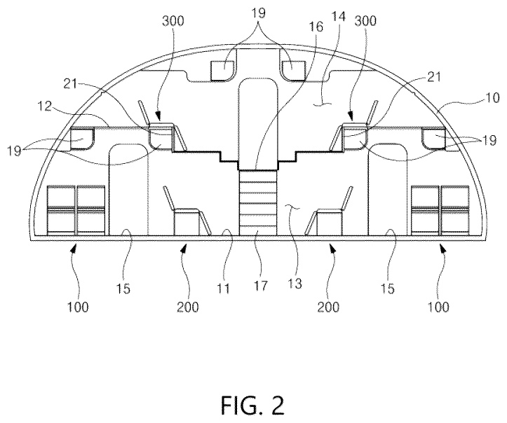

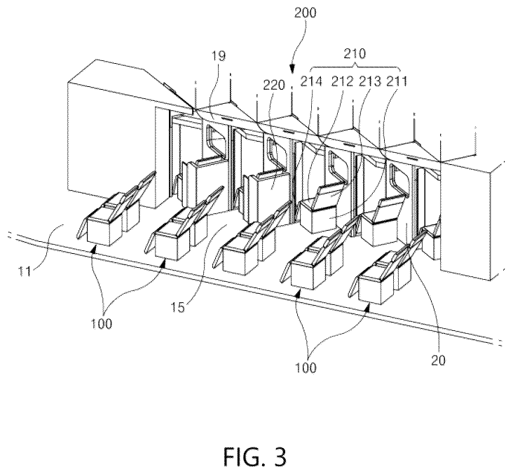

FIG. 1 is a perspective view schematically illustrating a seat system for an airplane according to a first exemplary embodiment of the present disclosure, FIG. 2 is a front cross-sectional view schematically illustrating that the seat system for the airplane illustrated in FIG. 1 is disposed on an airplane body, and FIG. 3 is a perspective view illustrating regions of a side seat part and a first seat part illustrated in FIG. 1.

As illustrated in these drawings, a seat system 1 of an airplane according to the exemplary embodiment includes a lower seat system provided in a first space part 13 of an airplane body 10 and an upper seat system provided in a second space part 14 disposed above the first space part 13.

In the exemplary embodiment, the lower seat system includes a side seat part 100 and a first seat part 200 illustrated in FIG. 1, and the upper seat system includes a plurality of second seat parts 300 having a V-shaped arrangement structure.

As illustrated in FIG. 2, the side seat part 100 may be provided at both side edges of the first space part 13 provided in the airplane body 10 to serve as a seating area for passengers.

In the exemplary embodiment, as illustrated in FIG. 1, the side seat part 100 includes a plurality of side seat bodies 110 arranged in a straight line in a direction from the head to the tail of the airplane. In FIG. 1, the head direction is illustrated with a narrow horizontal width, and the tail direction is illustrated with a wider horizontal width than the head direction.

In the exemplary embodiment, the side seat bodies 110 may be disposed in two rows on the left edge and two rows on the right edge with reference to FIG. 1.

As illustrated in FIG. 1, the side seat body 110 includes a support body 111 coupled to a first bottom part 11, a hip support body 112 coupled to the upper portion of the support body 111 to support the hips of the passenger, a back support body 113 coupled to the hip support body 112 so as to be angled to support the back or head of the passenger, and a leg support body 114 coupled to the hip support body 112 to support the legs of a user.

As illustrated in FIG. 1, the first seat part 200 may be coupled to the first bottom part 11 to be disposed between a pair of side seat parts 100.

In the exemplary embodiment, the first seat part 200 may be disposed in one row in close to the side seat part 100 disposed at the left edge, and disposed in one row in close to the side seat part 100 disposed at the right edge.

In addition, in the exemplary embodiment, the first seat part 200 may be provided to have an overall V-shaped arrangement shape, like the second seat part 300.

In the exemplary embodiment, as illustrated in FIG. 3, the first seat part 200 includes a first seat body 210 coupled to the first bottom part 11.

In the exemplary embodiment, as illustrated in FIG. 3, the first seat body 210 includes a first support body 211 coupled to the first bottom part 11, a first hip support body 212 coupled to the upper portion of the first support body 211 to support the hips of the passenger, a first back support body 213 coupled to the first hip support body 212 so as to be angled to support the back or head of the passenger, and a first leg support body 214 coupled to the first hip support body 212 to support the legs of the user.

In the exemplary embodiment, as illustrated in the front side of FIG. 3, the first seat part 200 further includes a blocking body 220 disposed close to the first seat body 210 to block a line of sight with the passenger sitting on the side seat part 100.

In addition, in the exemplary embodiment, in the region where the first seat part 200 is provided, as illustrated in FIG. 3, a plurality of support partitions 20 are spaced apart from each other to support the second bottom part 12 of the airplane body 10. In the exemplary embodiment, holes or transparent windows may be provided in the plurality of support partitions 20.

In the exemplary embodiment, as illustrated in FIG. 3, a shelf box 19 capable of accommodating portable items of passengers may be provided in the region where the first seat part 200 is provided.

In the exemplary embodiment, the above-described shelf box 19 or shelf may be provided in the front region of the first seat part 200 partitioned by the support partition 20.

As illustrated in FIG. 2, the plurality of second seat parts 300 are provided in the second space part 14 of the airplane body 10, and have a V-shaped arrangement structure as illustrated in FIG. 1.

In the exemplary embodiment, as illustrated in FIG. 1, the plurality of second seat parts 300 includes a second seat body 310 provided as a seating area for passengers, and a seat accommodating body 320 which blocks the lines of sight of passengers seated on the second seat body 310 and other passengers and accommodates the second seat body 310 therein.

In the exemplary embodiment, as illustrated in FIG. 1, the second seat body 310 includes a second hip support body 311, a second back support body 312 coupled to the second hip support body 311 so as to be angled to support the back or head of the passenger, and a second leg support body 313 coupled to the second hip support body 311 to support the legs of the user.

In the exemplary embodiment, unlike the side seat body 110 and the first seat body 210 described above, the second hip support body 311 is not provided with the support body 111, and as illustrated in FIG. 2, the second hip support body 311 may be screwed, bolted, or welded to the second bottom part 12 in a region close to a stepped part 21 provided on the second bottom part 12. To this end, as illustrated in FIG. 2, a central region of the second space part 14 may be provided to be recessed in the direction of the first bottom part 11 or may be provided to be recessed in a step shape.

In the exemplary embodiment, as illustrated in FIG. 1, the seat accommodating body 320 includes a front wall 321 disposed in the head direction of the airplane body 10, a first side wall 322 provided at one end of the front wall 321, a rear wall 323 provided at one end of the first side wall 322 and disposed in parallel with the front wall 321, a second side wall 324 provided at one end of the rear wall 323 and disposed in parallel with the first side wall 322 and shorter than the first side wall 322, and a body door 325 provided on the second side wall 324.

In the exemplary embodiment, the plurality of second seat parts 300 may be disposed so that the first side wall 322 and the second side wall 324 come into contact with each other.

In the exemplary embodiment, the first side wall 322 and the second side wall 324 may be detachably coupled to each other with a fastening member, and the fastening member may include bolts, nuts, and screws.

In the exemplary embodiment, the second seat part 300, as illustrated in FIG. 1, may be disposed above the first seat part 200.

In the exemplary embodiment, the passengers may conveniently move to the second part 12 through a first step 17 disposed in front of the first bottom part 11 and a second step 18 disposed behind the first bottom part 11.

In the exemplary embodiment, the structure of the airplane body 10 applied to the first exemplary embodiment may be equally applied to other exemplary embodiments to be described below.

Meanwhile, in the exemplary embodiment, a monitor 700 and a table 800 may be provided on at least one of the side seat part 100, the first seat part 200, and the second seat part 300. In the exemplary embodiment, the table 800 may have a known coupling means such as sliding coupling, hinge coupling, or the like. The monitor 700 and the table 800 described above may be equally applied to exemplary embodiments to be described below.

In the exemplary embodiment, the side seat body 110, the first seat body 210, and the second seat body 310 may be applied with a known airplane seat structure such as an electric drive or a manual drive as it is.

In the exemplary embodiment, the airplane body 10 may be provided with a pair of first corridors 15 and a second corridor 16 in the second space part 14 above the first corridor 15, as illustrated in FIG. 2. In addition, as illustrated in FIG. 1, four toilets 22 may be provided to be spaced apart from each other in the airplane body 10.

In addition, in the exemplary embodiment, as illustrated in FIG. 2, a body step 23 may be provided in the airplane body 10. In the exemplary embodiment, the body steps 23 may be provided on the left and right sides of the second corridor 16 based on FIG. 2.

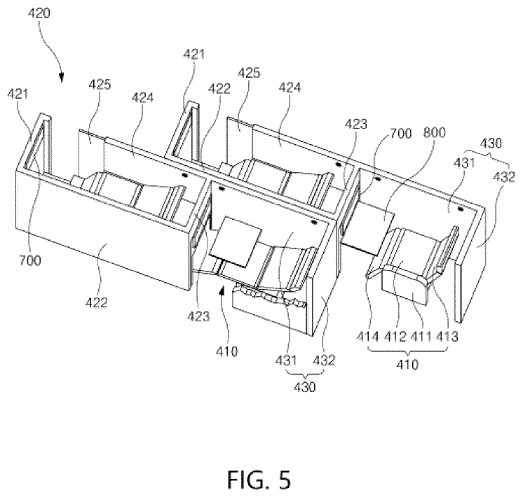

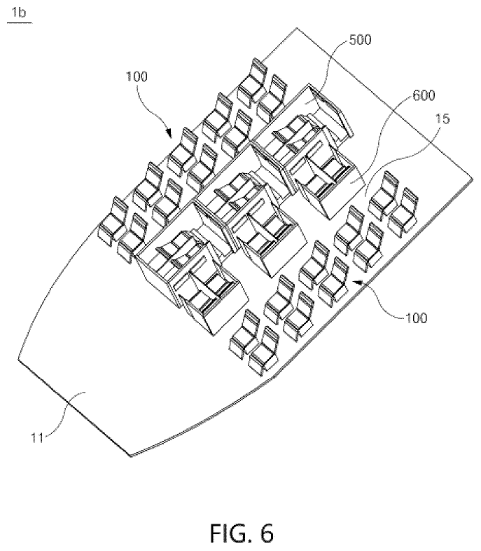

FIG. 4 is a perspective view schematically illustrating a seat system for an airplane according to a second exemplary embodiment of the present disclosure and FIG. 5 is a perspective view illustrating a third seat part 400 illustrated in FIG. 4.

An upper seat system of a seat system 1a of an airplane according to the exemplary embodiment includes a plurality of third seat parts 400 having a hatched arrangement structure. In the exemplary embodiment, the plurality of third seat parts 400 may also be provided on the first bottom part 11 of the lower seat system.

In the exemplary embodiment, as illustrated in FIG. 4, the plurality of third seat parts 400 includes a third seat body 410 provided as a seating area for passengers, a first accommodating body 420 which blocks the lines of sight of passengers seated on the third seat body 410 and other passengers and accommodates the third seat body 410 therein, a second accommodating body 430 provided with a space separated from the first accommodating body 420 and accommodating the third seat body 410 therein, a first toilet 440 provided in the head direction so as to be disposed in front of the third seat body 410 disposed in the foremost side, and a second toilet 450 provided in the tail direction so as to be disposed behind the third seat body 410 disposed at the rearmost side.

In the exemplary embodiment, as illustrated in FIG. 5, the third seat body 410 includes a third support body 411, a third hip support body 412 coupled to the upper portion of the third support body 411 to support the hips of the passenger, a third back support body 413 coupled to the third hip support body 412 so as to be angled to support the back or head of the passenger, and a third leg support body 414 coupled to the third hip support body 412 to support the legs of the user.

In the exemplary embodiment, when the third support body 411 is provided on the upper seat system, the third support body 411 may be coupled to the second bottom part 12, and when provided on the lower seat system, the third support body 411 may be coupled to the first bottom part 11.

In the exemplary embodiment, as illustrated in FIG. 5, the third seat bodies 410 may be provided in the first accommodating body 420 and the second accommodating body 430, respectively.

In the exemplary embodiment, as illustrated in FIG. 5, the first accommodating body 420 includes a first body wall 421, a second body wall 422 provided at one end of the first body wall 421, a third body wall 423 provided at one end of the second body wall 422 and disposed in parallel with the first body wall 421, a fourth body wall 424 provided at one end of the third body wall 423 and disposed in parallel with the second body wall 422, and a first door 425 provided on the fourth body wall 424.

In the exemplary embodiment, the first door 425 may include a known door type such as a slide type, a curtain type, or a hinge type, which may be applied to all of the above-described exemplary embodiments or exemplary embodiments to be described below.

In the exemplary embodiment, as illustrated in FIG. 5, the second accommodating body 430 includes a fifth body wall 431 provided on the third body wall 423 and disposed in a straight line with the fourth body wall 424, and a sixth body wall 432 provided at an end of the fifth body wall 431 and disposed in parallel with the third body wall 423.

In the exemplary embodiment, in the third seat part 400, as illustrated in FIGS. 4 and 5, the second body wall 422 may be disposed in contact with the fourth body wall 424 and the fifth body wall 431.

In the exemplary embodiment, the second body wall 422 may be detachably coupled to the fourth body wall 424 and the fifth body wall 431 by using a fastening member. In the exemplary embodiment, the fastening member may include bolts and nuts, or screws.

In the exemplary embodiment, as illustrated in FIG. 4, a first toilet 440 may be provided in the head direction so as to be disposed in front of the third seat body 410 disposed in the foremost side.

In the exemplary embodiment, the first toilet 440 may have a triangular planar shape as illustrated in FIG. 4, in order to harmonize with the structure in which the third seat part 400 is disposed in a hatched shape.

In the exemplary embodiment, as illustrated in FIG. 4, a second toilet 450 may be provided in the tail direction so as to be disposed behind the third seat body 410 disposed in the rearmost side.

In the exemplary embodiment, the second toilet 450 may have a triangular planar shape as illustrated in FIG. 4, in order to harmonize with the structure in which the third seat part 400 is disposed in a hatched shape. In the exemplary embodiment, the second toilet 450 may be disposed in a bilateral symmetrical direction with the first toilet 440.

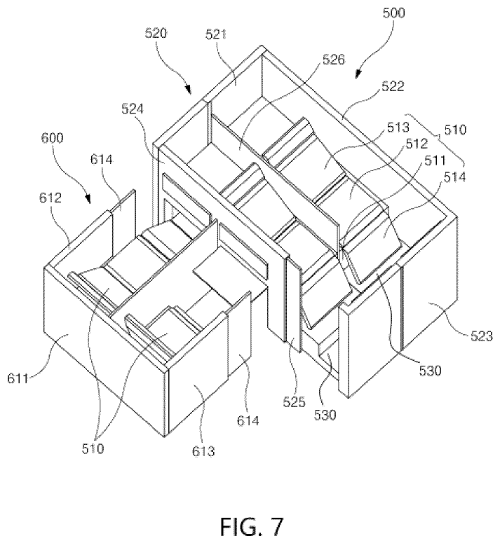

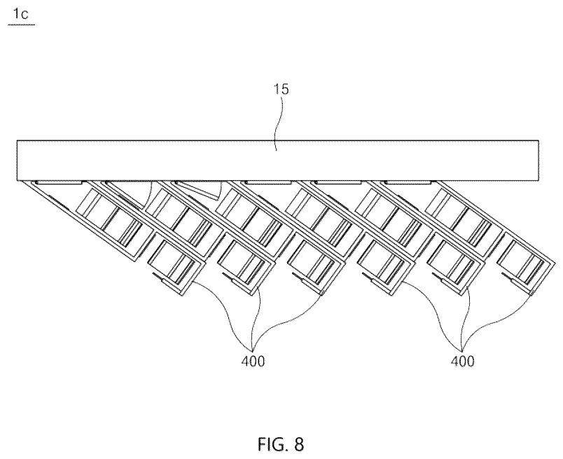

FIG. 6 is a perspective view schematically illustrating a seat system for an airplane according to a third exemplary embodiment of the present disclosure and FIG. 7 is a perspective view schematically illustrating a fourth seat part 500 and a fifth seat part 600 illustrated in FIG. 6.

An upper seat system of a seat system 1b of an airplane according to the exemplary embodiment includes a plurality of fourth seat parts 500 having a linear arrangement structure. In the exemplary embodiment, the plurality of fourth seat parts 500 may also be provided on the first bottom part 11 of the lower seat system.

As illustrated in FIGS. 6 and 7, the plurality of fourth seat parts 500 include a fourth seat body 510 provided as a seating area for passengers, a third accommodating body 520 which blocks the lines of sight of passengers seated on the fourth seat body 510 and other passengers and accommodates the fourth seat body 510 therein, and a seat step 530 provided inside the third accommodating body 520.

In the exemplary embodiment, as illustrated in FIG. 7, the fourth seat body 510 includes a fourth support body 511, a fourth hip support body 512 coupled to the upper portion of the fourth support body 511 to support the hips of the passenger, a fourth back support body 513 coupled to the fourth hip support body 512 so as to be angled to support the back or head of the passenger, and a fourth leg support body 514 coupled to the fourth hip support body 512 to support the legs of the user.

In the exemplary embodiment, when the fourth support body 511 is provided on the upper seat system, the fourth support body 511 may be coupled to the second bottom part 12, and when provided on the lower seat system, the fourth support body 511 may be coupled to the first bottom part 11.

In the exemplary embodiment, as illustrated in FIG. 7, the third accommodating body 520 includes a seventh body wall 521, an eighth body wall 522 provided at one end of the seventh body wall 521, a ninth body wall 523 provided at one end of the eighth body wall 522 and disposed in parallel with the seventh body wall 521, a tenth body wall 524 provided at the other end of the seventh body wall 521 and disposed in parallel with the eighth body wall 522, a second door 525 provided on the tenth body wall 524, and a partition wall 526 provided on the seventh body wall 521 to block the lines of sight of passengers seated on the pair of fourth seat bodies 510.

In the exemplary embodiment, as illustrated in FIG. 7, the seat step 530 is provided in the third accommodating body 520 so as to be close to the fourth leg support body 514, so that passengers may conveniently use the fourth seat body 510. In the exemplary embodiment, the seat step 530 may be provided by providing a step to the airplane body 10. In addition, in the exemplary embodiment, the seat step 530 may also be prepared by providing a step on the upper surface of the bottom after preparing the bottom part on the third accommodating body 520.

Meanwhile, in the exemplary embodiment, the plurality of fourth seat parts 500 further include a fifth seat part 600 disposed vertically to the fourth seat body 510 and provided as a seating area for passengers.

In the exemplary embodiment, the fifth seat part 600 includes the aforementioned fourth seat body 510 and a fourth accommodating body 610 in which the fourth seat body 510 is accommodated.

In the exemplary embodiment, as illustrated in FIG. 7, the fourth accommodating body 610 includes an eleventh body wall 611 disposed in parallel with the tenth body wall 524, a twelfth body wall 612 provided at one end of the eleventh body wall 611 and disposed in parallel with the seventh body wall 521, a thirteenth body wall 613 provided at the other end of the eleventh body wall 611 and disposed in parallel with the twelfth body wall 612, and a third door 614 provided on the twelfth body wall 612 and the thirteenth body wall 613.

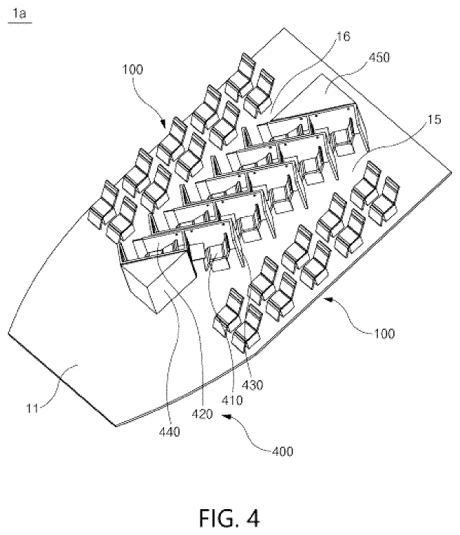

FIG. 8 is a perspective view schematically illustrating a seat system for an airplane according to a fourth exemplary embodiment of the present disclosure.

As illustrated in FIG. 8, a seat system 1c of the airplane according to this exemplary embodiment may also be provided in a hatched shape in a second passage.

At this time, a seat part is illustrated in another exemplary embodiment of the third seat part 400 in which the first body wall 421 is excluded and the first door 425 is provided on the second body wall 422, but is not limited thereto and the seat part of the exemplary embodiment described above may be selectively applied.

The exemplary embodiment may also be applied to a lower seat system.

As described above, the present disclosure is not limited to the exemplary embodiments described herein, and it will be apparent to those skilled in the art that various changes and modifications may be made without departing from the spirit and the scope of the present disclosure. Therefore, it will be understood that these changes and modifications are included in the appended claims of the present disclosure.

1,1a, 1b, 1c: Seat system of airplane

| | |
|---|---|
| 100: Side seat part | 110: Side seat body |
| 111: Support body | 112: Hip support body |
| 113: Back support body | 114: Leg support body |
| 200: First seat part | 210: First seat body |
| 211: First support body | 212: First hip support body |
| 213: First back support body | 214: First leg support body |
| 220: Blocking body | 300: Second seat part |
| 310: Second seat body | 311: Second hip support body |
| 312: Second back support body | 313: Second leg support body |
| 320: Seat accommodating body | 321: Front wall |
| 322: First side wall | 323: Rear wall |
| 324: Second side wall | 325: Body door |
| 400: Third seat part | 410: Third seat body |
| 411: Third support body | 412: Third hip support body |
| 413: Third back support body | 414: Third leg support body |
| 420: First accommodating body | 421: First body wall |
| 422: Second body wall | 423: Third body wall |
| 424: Fourth body wall | 425: First door |
| 430: Second accommodating body | 431: Fifth body wall |
| 432: Sixth body wall | 440: First toilet |
| 450: Second toilet | 500: Fourth seat part |
| 510: Fourth seat body | 511: Fourth support body |
| 512: Fourth hip support body | 513: Fourth back support body |
| 514: Fourth leg support body | 520: Third accommodating body |
| 521: Seventh body wall | 522: Eighth body wall |
| 523: Ninth body wall | 524: Tenth body wall |
| 525: Second door | 526: Partition wall |
| 530: Seat step | 600: Fifth seat part |
| 610: Fourth accommodating body | 611: Eleventh body wall |
| 612: Twelfth body wall | 613: Thirteenth body wall |
| 614: Third door | 600: Monitor |
| 700: Table | 10: Airplane body |
| 11: First bottom part | 12: Second bottom part |
| 13: First space part | 14: Second space part |
| 15: First corridor | 16: Second corridor |
| 17: First step | 18: Second step |
| 19: Shelf box | 20: Support partition |
| 21: Step part | 22: Toilet |
| 23: Body step | |

What is claimed is:

1. A seat system for an airplane comprising:
a lower seat system provided in a first space part of an airplane body; and
an upper seat system provided in a second space part disposed above the first space part,
wherein the upper seat system includes a plurality of seat parts,
the plurality of seat parts have at least one arrangement structure selected from a V-shaped arrangement structure, a linear arrangement structure, and a hatched arrangement structure, and
the plurality of seat parts is continuously arranged.

2. The seat system for the airplane of claim 1, wherein the lower seat system comprises
a side seat part provided in the first space part; and
a first seat part disposed to be spaced apart from the side seat part.

3. The seat system for the airplane of claim 2, wherein the side seat parts are disposed on both sides of the first seat part and are arranged in a straight line in a direction from the head to the tail of the airplane body.

4. The seat system for the airplane of claim 2, wherein a pair of first corridors are provided in the first space part, and
the first seat part includes a first seat body provided between the pair of first corridors and provided as a seating area for a user.

5. The seat system for the airplane of claim 4, wherein the first seat part further comprises a blocking body disposed close to the first seat body to block a line of sight with the passenger sitting on the side seat part.

6. The seat system for the airplane of claim 4, wherein in the first space part in the region where the first seat part is provided, a plurality of support partitions are provided to support a bottom part of the second space part.

7. The seat system for the airplane of claim 1, wherein the plurality of seat parts having the V-shaped arrangement structure comprise a plurality of second seat parts disposed in a V-shape with a second corridor provided in the second space part interposed therebetween.

8. The seat system for the airplane of claim 7, wherein the plurality of second seat parts comprises
a second seat body provided as a seating area for passengers; and
a seat accommodating body configured to block the lines of sight of passengers seated on the second seat body and other passengers and accommodate the second seat body therein.

9. The seat system for the airplane of claim 8, wherein the seat accommodating body comprises
a front wall disposed in the head direction of the airplane body;
a first side wall provided at one end of the front wall;
a rear wall provided at one end of the first side wall and disposed in parallel with the front wall;
a second side wall provided at one end of the rear wall and disposed in parallel with the first side wall; and
a body door provided on the second side wall.

10. The seat system for the airplane of claim 9, wherein the plurality of second seat parts are disposed so that the first side wall and the second side wall come into contact with each other.

11. The seat system for the airplane of claim 10, wherein the first side wall and the second side wall are detachably coupled to each other with a fastening member.

12. The seat system for the airplane of claim 1, wherein the plurality of seat parts having the V-shaped arrangement structure is disposed above a first seat part provided in the lower seat system.

13. The seat system for the airplane of claim 1, wherein the plurality of seat parts having the hatched arrangement structure comprise a plurality of third seat parts arranged in a hatched shape in the second space part.

14. The seat system for the airplane of claim 13, wherein the plurality of third seat parts comprises
a third seat body provided as a seating area for passengers;
a first accommodating body configured to block the lines of sight of passengers seated on the third seat body and other passengers and accommodate the third seat body therein; and
a second accommodating body provided with a space separated from the first accommodating body and accommodating the third seat body therein.

15. The seat system for the airplane of claim 14, wherein the first accommodating body comprises
a first body wall;
a second body wall provided at one end of the first body wall;
a third body wall provided at one end of the second body wall and disposed in parallel with the first body wall;
a fourth body wall provided at one end of the third body wall and disposed in parallel with the second body wall; and
a first door provided on the fourth body wall.

16. The seat system for the airplane of claim 15, wherein the second accommodating body comprises
a fifth body wall provided on the third body wall and disposed in a straight line with the fourth body wall; and
a sixth body wall provided at an end of the fifth body wall and disposed in parallel with the third body wall.

17. The seat system for the airplane of claim 16, wherein in the third seat part, the second body wall is disposed in contact with the fourth body wall and the fifth body wall.

18. The seat system for the airplane of claim 17, wherein the second body wall is detachably coupled to the fourth body wall and the fifth body wall by using a fastening member.

19. The seat system for the airplane of claim 1, wherein the plurality of seat parts having the linear arrangement structure comprise a plurality of fourth seat parts arranged in a linear shape in the second space part.

20. The seat system for the airplane of claim 19, wherein the plurality of fourth seat parts comprises
a fourth seat body provided as a seating area for passengers; and
a third accommodating body configured to block the lines of sight of passengers seated on the fourth seat body and other passengers and accommodate the fourth seat body therein.

21. The seat system for the airplane of claim 20, wherein a pair of fourth seat bodies is provided in the third accommodating body, and
the third accommodating body is provided with a partition wall to block the lines of sight of passengers seated on the pair of fourth seat bodies.

22. The seat system for the airplane of claim 20, wherein the plurality of fourth seat parts further comprises a fifth seat part disposed vertically to the fourth seat body and provided as a seating area for passengers.

23. The seat system for the airplane of claim 1, further comprising:
the lower seat system and a monitor and a table provided in the lower seat system.

24. An airplane comprising:
an airplane body having a first space part and a second space part disposed above the first space part;
a lower seat system provided in the first space part; and
an upper seat system provided in the second space part,
wherein the upper seat system includes a plurality of seat parts,
the plurality of seat parts have at least one arrangement structure selected from a V-shaped arrangement structure, a linear arrangement structure, and a hatched arrangement structure, and
the plurality of seat parts is continuously arranged.

25. The airplane of claim 24, wherein the airplane body comprises
a plurality of shelf boxes;
a pair of first corridors disposed to be spaced apart from each other in the first space part;
a first step provided to move from the first space part to the second space part; and
a second step provided to move from the first space part to the second space part and spaced apart from the first step.
